(19) United States
(12) Patent Application Publication
(10) Pub. No.: US 2010/0081301 A1
(43) Pub. Date: Apr. 1, 2010

(54) TWO-PIN PLUG-IN COMPONENT AND PRINTED CIRCUIT BOARD ENGAGABLE WITH THE SAME

(75) Inventor: XIANG CAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/266,566

(22) Filed: Nov. 7, 2008

(30) Foreign Application Priority Data
Sep. 26, 2008 (CN) 200810304705.7

(51) Int. Cl. H01R 12/00

(52) U.S. Cl. 439/78

(57) ABSTRACT

A two-pin plug-in component includes a main body, a first pin, and a second pin. The first pin and the second pin are correspondingly connected to an anode and a cathode of the main body, and are set on a bottom of the main body. The first and second pins are non-centrosymmetric on the bottom of the main body.

### BACKGROUND

1. Technical Field

The present disclosure relates to plug-in components and printed circuit boards (PCBs) and, particularly, to a two-pin plug-in component and a PCB engagable with the two-pin plug-in component.

2. Description of Related Art

Plug-in components are widely used in different fields, such as electronic fields. One such two-pin plug-in component generally includes a main body, a positive pin and a negative pin correspondingly connected to an anode and a cathode of the main body. If the two-pin plug-in component needs to be mounted to a PCB defining a first hole and a second hole, the positive pin and the negative pin of the two-pin plug-in component are inserted into the first hole and the second hole of the PCB, respectively.

However, the positive and negative pins generally have similar shapes, and two-pin plug-in component may be inversely connected, i.e., the positive pin is connected to a spot where the negative pin should be, and vice versa, thereby making the two-pin plug-in component under the risk of explosion.

What is needed, therefore, it is to provide a two-pin plug-in component and a PCB engagable with the same to overcome the above described shortcomings.

### BRIEF DESCRIPTION OF THE DRAWINGS

FIG. 1 is an isometric view of an exemplary embodiment of a two-pin plug-in component.

FIG. 2 is a plan view of the two-pin plug-in component of FIG. 1, viewing from the pin side.

FIG. 3 is a schematic view of an exemplary embodiment of a printed circuit board (PCB), the PCB including a fixing device.

FIG. 4 is an isometric view of the fixing device of the PCB of FIG. 3.

### DETAILED DESCRIPTION

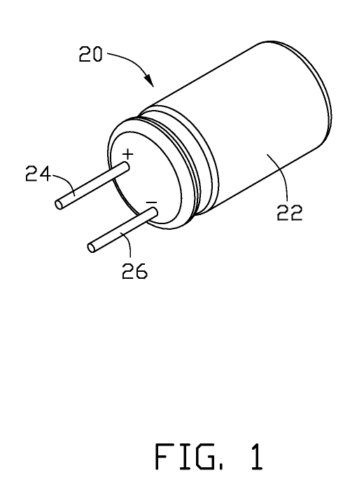

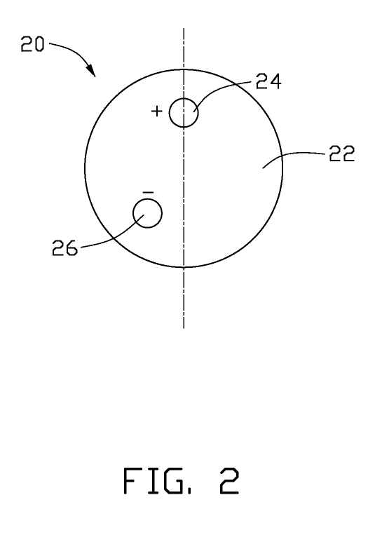

Referring to FIGS. 1 and 2, an exemplary embodiment of a two-pin plug-in component takes an electrolytic capacitor 20 for example. The electrolytic capacitor 20 includes a cylindrical main body 22, a cylindrical first pin 24, and a cylindrical second pin 26. The first pin 24 electrically connected to an anode of the capacitor 20 can be a metal pin, and at an off-centered position along a first symmetrical axis of a round bottom of the main body 22. The second pin 26 electronically connected to a cathode of the capacitor 20 can be a metal pin, and at an off-centered position along a second symmetrical axis of the bottom of the main body 22. The first pin 24 and the second pin 26 lie along different symmetrical axial lines of the bottom of the main body 22.

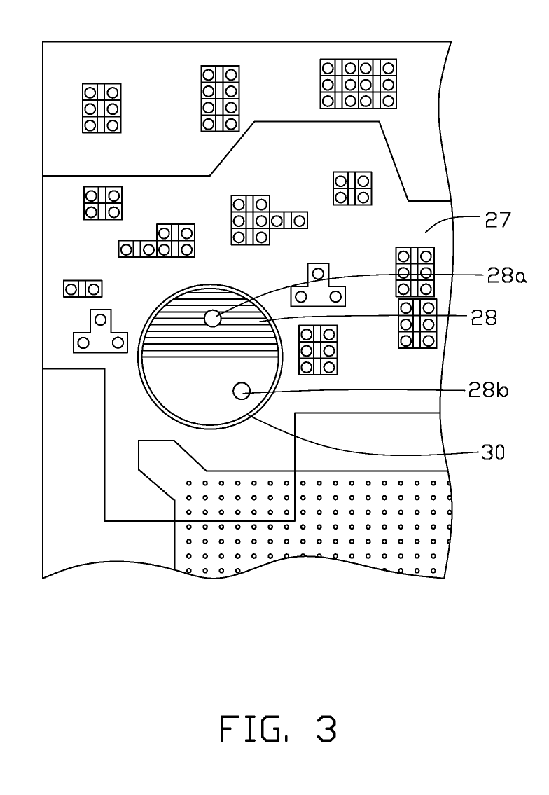

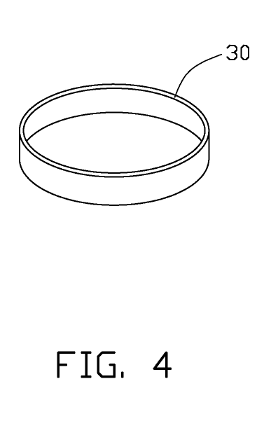

Referring to FIGS. 3 and 4, an exemplary embodiment of a printed circuit board (PCB) 27 includes a board body (not labeled) configured for mounting the electrolytic capacitor 20. A fixing device, such as a plastic ring 30, configured for encircling and resisting against the main body 22 of the electrolytic capacitor 20 is set on the board body of the PCB 27. The fixing ring 30 can be welded or stuck on the PCB 27 and forms a loop thereby, defining a round capacitor region 28. A round first hole 28a and a round second hole 28b corresponding to the first pin 24 and the second pin 26 are defined in the capacitor region 28. For instance, the first hole 28a is defined at an off-centered position along a first symmetrical axis of the capacitor region 28, the second hole 28b is defined at an off-centered position along a second symmetrical axis the capacitor region 28. The first hole 28a and the second hole 28b lie along different symmetrical axial lines of the capacitor region 28.

The first pin 24 and the second pin 26 of the electrolytic capacitor 20 can be correspondingly inserted into the first hole 28a and the second hole 28b of the PCB 27. Because of the limitation of the capacitor region 28, the capacitor 20 can only be connected to the PCB in one orientation such that the first pin 24 and the second pin 26 is aligned and insertable with the first hole 28a and the second hole 28b, thus, preventing the capacitor 20 from damaging due to inverted connection.

In other embodiments, the first pin 24 and the second pin 26 can be set on the main body 22 varying with different bottom shapes of the main body 22, to ensure that the first pin 24 and the second pin 26 are non-centrosymmetric on the bottom of the main body 22. For instance, the first pin 24 can be set on a symmetry axis of the bottom of the main body 22, the second pin 26 can be deviated from the symmetry axis on which the first pin 24 is set. The shape of the fixing device can vary with different shapes of the main body 22.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A two-pin plug-in component comprising:
a main body comprising an anode and a cathode;
a first pin electrically connected to the anode of the main body; and
a second pin electrically connected to the cathode of the main body;
wherein the first pin and the second pin are both set on a bottom of the main body, and wherein the first pin is at an off centered position along a first symmetry axis of the bottom of the main body, and the second pin is at an off centered position along a second symmetry axis of the bottom of the main body to prevent inverted connection.

2. (canceled)

3. The two-pin plug-in component of claim 1, wherein the first pin and the second pin are both metal pins and have cylinder shapes.

4. The two-pin plug-in component of claim 1, wherein the bottom of the main body is round.

5. The two-pin plug-in component of claim 1, wherein the two-pin plug-in component is an electrolytic capacitor.

6-10. (canceled)
